(19) United States
(12) Patent Application Publication
(10) Pub. No.: US 2017/0256270 A1
(43) Pub. Date: Sep. 7, 2017

(54) Voice Recognition Accuracy in High Noise Conditions

(71) Applicant: Motorola Mobility LLC, Chicago, IL (US)

(72) Inventors: Snehitha Singaraju, Naperville, IL (US); Joel Clark, Woodridge, IL (US); Christian Flowers, Chicago, IL (US); Mark A. Jasiuk, Chicago, IL (US); Pratik M. Kamdar, Naperville, IL (US)

(21) Appl. No.: 15/058,636

(22) Filed: Mar. 2, 2016

(51) Int. Cl. G10L 21/0216; G10L 25/21; G10L 15/22; G10L 25/84

(52) U.S. Cl. CPC G10L 21/0216; G10L 25/84; G10L 25/21; G10L 15/22; G10L 2015/223

(57) ABSTRACT

Systems and methods for voice recognition determine energy levels for speech and noise and generate adaptive thresholds based on the determined energy levels. The adaptive thresholds are applied to determine the presence of speech and to generate noise-dependent triggers for indicating the presence of speech during high-noise conditions. In an embodiment, the signal energy is averaged in the presence of speech and in the presence of background noise. Audio energy calculations may be made by averaging via a sliding window or via a memory filter.

### TECHNICAL FIELD

The present disclosure is related generally to mobile communication devices, and, more particularly, to a system and method for speech detection in a mobile communication device.

### BACKGROUND

As mobile devices continue to shrink in size and weight, voice interface systems are supplementing and supplanting graphical user interface (GUI) systems for many operations. However, typical voice recognition engines are not able to reliably distinguish a user's voice from ambient background noise. Moreover, even when a user's voice is identified from a high-noise background, the confidence score identifying the user as the owner or intended user of the device may be low. Thus, while voice recognition thresholds may be lowered to allow easier identification of a user's voice in high-noise environments, this will also increase the likelihood of “False Accepts,” where the device “responds” even in the absence of a user action.

While the present disclosure is directed to a system that can eliminate certain shortcomings noted in or apparent from this Background section, it should be appreciated that such a benefit is neither a limitation on the scope of the disclosed principles nor of the attached claims, except to the extent expressly noted in the claims. Additionally, the discussion of technology in this Background section is reflective of the inventors' own observations, considerations, and thoughts, and is in no way intended to accurately catalog or comprehensively summarize the art currently in the public domain. As such, the inventors expressly disclaim this section as admitted or assumed prior art. Moreover, the identification or implication above of a desirable course of action reflects the inventors' own observations and ideas, and should not be assumed to indicate an art-recognized desirability.

### SUMMARY

In keeping with an embodiment of the disclosed principles, an audio signal containing noise and potentially containing speech is received and a noise energy level and a speech energy level are generated based on the received audio signal. An adaptive speech energy threshold is set at least in part based on the noise and speech energy levels, and the adaptive speech energy threshold may be modified as noise and speech energy levels change over time. The determined speech energy level is compared to the adaptive speech energy threshold and a presence signal indicating the presence of speech is generated when the determined speech energy level exceeds the adaptive speech energy threshold.

Other features and aspects of embodiments of the disclosed principles will be appreciated from the detailed disclosure taken in conjunction with the included figures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example configuration of device components with respect to which embodiments of the presently disclosed principles may be implemented;

FIG. 2 is a simulated data plot illustration showing audio signal noise effects in a low-noise environment;

FIG. 3 is a simulated data plot illustration showing audio signal noise effects in a high-noise environment;

FIG. 4 is a modular diagram of an adaptive threshold speech recognition engine in accordance with an embodiment of the disclosed principles;

FIG. 5 is a flowchart illustrating a process of adaptive threshold speech recognition in accordance with an embodiment of the disclosed principles; and

FIG. 6 is a flowchart showing a process for using a first and second utterance for model improvement in keeping with an embodiment of the disclosed principles.

### DETAILED DESCRIPTION

Before presenting a fuller discussion of the disclosed principles, an overview is given to aid the reader in understanding the later material. As noted above, typical voice recognition engines are not able to sufficiently distinguish a user's voice from ambient background noise. Moreover, even when a user's voice is identified from a noisy background, the confidence score identifying the user as the owner or intended user of the device may be low. While voice recognition thresholds may be lowered to allow identification in high-noise environments, this also results in False Accepts, where the device “responds” even in the absence of a user action.

In an embodiment of the disclosed principles, a voice recognition engine is used to identify the time intervals when speech is present. The voice recognition engine determines energy levels for speech and noise, with one or more thresholds being used to determine when the device will respond to the user. The energy threshold values may be specified relative to the maximum possible energy value, which is defined, for example, as 0 dB. A fixed threshold may be used for the minimum expected speech energy level (−36 dB, for instance).

Alternately, the thresholds for minimum speech energy and noise energy levels may be adapted based on ongoing monitoring of signal characteristics. In one such method, the signal energy is averaged when the voice recognition engine indicates the presence of speech (for the adapted speech energy level estimate) and is also averaged when the voice recognition engine indicates the presence of background noise (for the adapted noise level estimate). Thresholds are then set based at least in part on those two adaptive energy levels.

The averaging may be executed via a sliding time window, e.g., of a preselected duration, or alternately via a filter with memory. Stationary noise such as car noise can be identified and the thresholds can be adapted, for example, by setting a minimum number of frames for which the voice recognition engine is true and identifying the speech energy level as greater than a defined stationary noise floor. With respect to non-stationary noise, the threshold can be adapted by setting a minimum number of frames for which the voice recognition engine is true and identifying speech energy level as greater than a defined dynamic noise floor. The thresholds for stationary noise and non-stationary noise need not be the same.

The long term or medium term noise floors are then monitored in an embodiment, and when high noise is detected, a minimum SNR threshold is forced to be met to prevent False Accepts. The estimate of the SNR may be defined as a difference between the estimated speech level and the estimated noise level, e.g., expressed in dB. The SNR threshold is set adaptively based on noise level in an embodiment. For example, at higher noise levels, the SNR threshold may be set lower than it is at lower noise levels.

In an embodiment of the disclosed principles, noise conditions are monitored and a trigger or wakeup SNR is set depending on noise. In a high-noise environment, when the trigger is identified but the confidence score is low to establish the speaker as the owner of the device, the device may utilize a second trigger or ask for confirmation and improve the recognition models or thresholds. For example, the device may awake and display a query phrase such as “I think I heard you, but could you speak louder?” If the user responds with a command, the device can use the speech characteristics during the time the trigger word was first said and the noise characteristics during that time to improve its recognition model and update recognition thresholds specific to the user.

Another option is to ask the user to speak the trigger word again to continue. Alternatively, this second instance of the trigger word can be used to verify the speaker, verify if the confidence score has increased, use the speech and noise characteristics to improve recognition model for the user and lower the likelihood of False Accepts. The above solutions and others can be implemented independently or together to improve accuracy, mitigate False Accepts and improve the overall user experience.

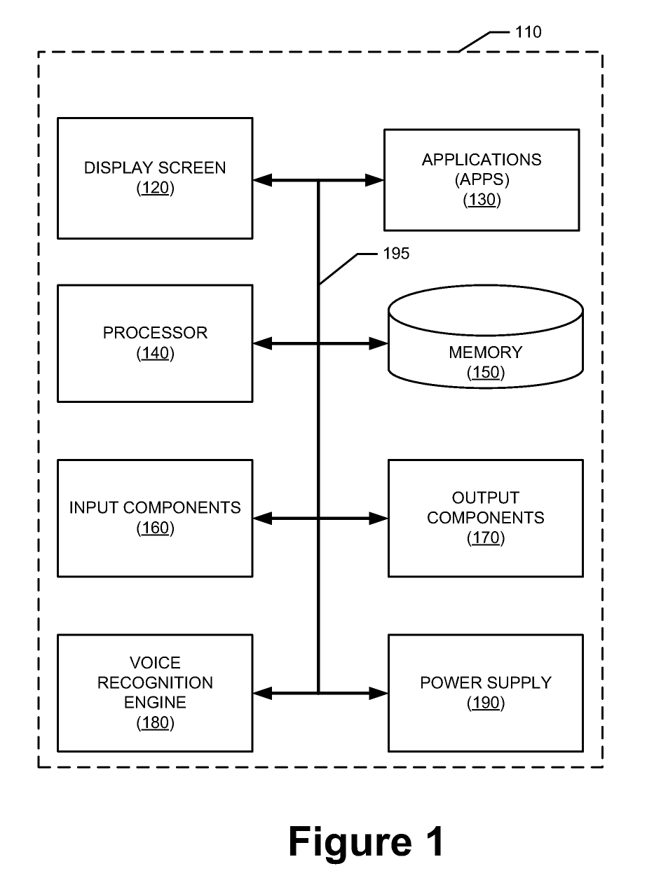

With this overview in mind, and turning now to a more detailed discussion in conjunction with the attached figures, the techniques of the present disclosure are illustrated as being implemented in a suitable computing environment. The following device description is based on embodiments and examples of the disclosed principles and should not be taken as limiting the claims with regard to alternative embodiments that are not explicitly described herein. Thus, for example, while FIG. 1 illustrates an example mobile device within which embodiments of the disclosed principles may be implemented, it will be appreciated that other device types may be used.

The schematic diagram of FIG. 1 shows an exemplary component group 110 forming part of an environment within which aspects of the present disclosure may be implemented. It will be appreciated that additional or alternative components may be used in a given implementation depending upon user preference, component availability, price point, and other considerations.

In the illustrated embodiment, the components 110 include a display screen 120, applications (e.g., programs) 130, a processor 140, a memory 150, one or more input components 160 such as speech and text input facilities (e.g., one or more microphones and a keyboard respectively), and one or more output components 170 such as one or more speakers. In an embodiment, the input components 160 include a physical or virtual keyboard maintained or displayed on a surface of the device. In various embodiments motion sensors, proximity sensors, camera/IR sensors and other types of sensors may be used collect certain types of input information such as user presence, user gestures and so on.

The processor 140 may be any of a microprocessor, microcomputer, application-specific integrated circuit, and like structures. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device. Such functions may include, for example, interaction among various internal components and storage and retrieval of applications and data to and from the memory 150.

Further with respect to the applications 130, these typically utilize the operating system to provide more specific functionality, such as file system services and handling of protected and unprotected data stored in the memory 150. Although some applications may provide standard or required functionality of the user device 110, in other cases applications provide optional or specialized functionality, and may be supplied by third party vendors or the device manufacturer.

Finally, with respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device 110 also includes a voice recognition engine 180, which is linked to the device input systems, e.g., the microphone (“mic”), and is configured via coded instructions to recognize user voice inputs. The voice recognition engine 180 will be discussed at greater length later herein.

In an embodiment, a power supply 190, such as a battery or fuel cell, is included for providing power to the device 110 and its components. All or some of the internal components communicate with one another by way of one or more shared or dedicated internal communication links 195, such as an internal bus.

In an embodiment, the device 110 is programmed such that the processor 140 and memory 150 interact with the other components of the device 110 to perform certain functions. The processor 140 may include or implement various modules and execute programs for initiating different activities such as launching an application, transferring data, and toggling through various graphical user interface objects (e.g., toggling through various display icons that are linked to executable applications). For example, the voice recognition engine 180 is implemented by the processor 140 in an embodiment.

Applications and software are represented on a tangible non-transitory medium, e.g., RAM, ROM or flash memory, as computer-readable instructions. The device 110, via its processor 140, runs the applications and software by retrieving and executing the appropriate computer-readable instructions.

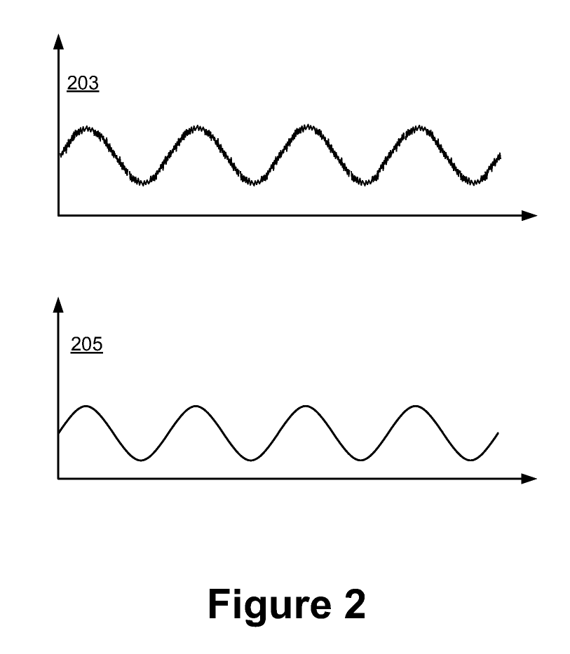

Turning to FIG. 2, this figure shows a set of simulated audio data plots showing combined voice and noise audio signal in a low noise environment (plot 203) as well as the noise-free voice signal (plot 205), that is signal in the absence of noise. The voice data is simulated as a sinusoidal signal. As can be seen, the combined voice and noise audio signal in a low noise environment shown in plot 203 bears strong similarity to the noise-free voice signal, and the confidence value for identification would be high in this environment.

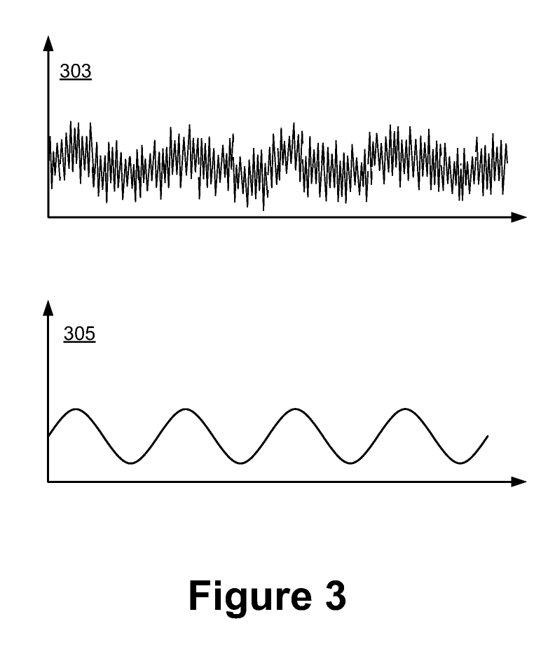

However, in a high-noise environment, identification is more difficult and the confidence value associated with identification may be much lower. By way of example, FIG. 3 shows a set of simulated audio data plots showing combined voice and noise audio signal in a high-noise environment (plot 303) as well as the noise-free voice signal (plot 305).

As can be seen, the combined voice and noise audio signal shown in plot 303 deviates significantly from the noise-free voice signal in plot 305 and consequently the confidence value for identification would be low in this environment. This could result in failure to accept a valid voice signal or, if thresholds were lowered to allow easier identification, would result in an increased likelihood of a False Accept and possible unauthorized access to the device.

Although these plots are simply illustrative, it will be appreciated that high-noise environments result in a low signal-to-noise ratio (SNR). The lowered SNR makes it difficult for the device in question to produce a voice recognition with sufficient confidence to allow robust voice input operation.

As noted above, in an embodiment of the disclosed principles, the voice recognition engine 180 is used to indicate when speech is present, even in higher noise environments, when ambient or background noise is prominent. The voice recognition engine 180 determines energy levels for speech and noise, with adaptive thresholds being used to determine when the device will respond to the user. The energy threshold values may be specified relative to the maximum possible energy value, which is defined, for example, as 0 dB. A fixed threshold may be used for the minimum expected speech energy level (−36 dB, for instance).

Alternately, the thresholds for minimum speech energy and noise energy levels may be adapted based on ongoing monitoring of signal characteristics. In one such method, the signal energy is averaged when the voice recognition engine 180 indicates the presence of speech (for the adapted speech energy level estimate) and is also averaged when the voice recognition engine 180 indicates the presence of background noise (for the adapted noise level estimate). Thresholds are then set based at least in part on those two adaptive energy levels.

The averaging may be executed via a sliding time window, e.g., of a preselected duration, or alternately via a filter with memory. Stationary noise such as car noise can be identified and the thresholds can be adapted, for example, by setting a minimum number of frames for which the voice recognition engine 180 is true and identifying the speech energy level as greater than a defined stationary noise floor. With respect to non-stationary noise, the threshold can be adapted by setting a minimum number of frames for which voice presence is true and identifying the speech energy level as greater than a defined dynamic noise floor. The thresholds for stationary noise and non-stationary noise need not be the same.

The long term or medium term noise floors are then monitored in an embodiment, and when high noise is detected, a minimum SNR threshold is enforced in order to prevent False Accepts. The estimate of the SNR need not be a true ratio, and in an embodiment the SNR is a function of the difference between the estimated speech level and the estimated noise level, e.g., expressed in dB. The SNR threshold is set adaptively based on the ambient noise level in an embodiment. For example, at higher noise levels, the SNR threshold may be set lower than it is at lower noise levels.

In an embodiment of the disclosed principles, noise conditions are monitored and a trigger or wakeup SNR is set depending on noise. In a high-noise environment, when the trigger is identified but the confidence score is low to establish the speaker as the owner of the device, the device may utilize a second trigger or ask for confirmation and improve the recognition models or thresholds. For example, the device may awake and display a query phrase such as “I think I heard you, but could you speak louder?”

If the user responds with a command, the device can mark the low scored trigger as a correctly identified trigger with a low score and use it for further refining the user's recognition model. These low scored trigger words can be used one at a time to improve the recognition model or a database can be actively maintained with these collected triggers. They can be compared with one another to note any natural speech variations occurring in the way the user is pronouncing the trigger word. They can also be compared against previously stored correctly identified trigger words with high confidence score. (This high confidence score database can be built via user training or by storing the trigger words identified with high confidence score.)

This information can be used to improve the recognition model for the user via adding some or all of the selected speech variations into the recognition model previously created. This is particularly helpful when the user pronounces the trigger word a certain way when training the recognition system and then naturally progressing into using multiple pronunciations of the trigger word. For example, the cadence at which the trigger word is spoken will often change.

Alternately, the noise characteristics during, before and after the time period when the low scored trigger was said can also be used to improve the recognition model. The noise characteristics can be added to the training models, or the model be retrained or simply allow for these speech variations and noise variations into the recognition model. User specific thresholds such as speaker verification or thresholds used for detection or minimizing false accepts can also be modified using this information.

Another option is to ask the user to speak the trigger word again or to speak a second trigger word to verify the speaker, increase the confidence score, and lower the likelihood of False Accepts. In this use case, the second trigger word confirms the user's intention to wake up the phone and gives the user an opportunity to repeat the trigger word with an increased confidence score to allow for usage of the device. This approach may be desirable over the having device not respond to the user at all (which means low trigger accuracy for the device).

Routinely responding with low confidence scores will increase the likelihood of False Accepts. In contrast, the first and the second trigger words can be used to improve the recognition model for the user. They can be compared with one another to note any natural speech variations occurring in the way the user is pronouncing the trigger word. They can also be compared against previously stored correctly identified trigger words with high confidence scores. (The high confidence score database can be built via user training or by storing the trigger words identified with high confidence score.) This information can be used to improve the recognition model for the user by adding some or all of the detected speech variations into the recognition model previously created.

This technique may be particularly helpful when the user pronounces the trigger word a certain way when training the recognition system and then later progresses into using one or more variations of that pronunciation. For example, the cadence with which the trigger word is uttered may change. Alternately, the noise characteristics during, before and after utterance of the low scored trigger can also be used to improve the recognition model. The noise characteristics can be added to the training models, or the model can be retrained or may simply allow for these speech variations and noise variations in the recognition model. User-specific thresholds such as speaker verification or thresholds used for detection or minimizing false accepts can also be modified using this information. The above solutions and others can be implemented independently or together to improve accuracy, mitigate False Accepts and improve the overall user experience.

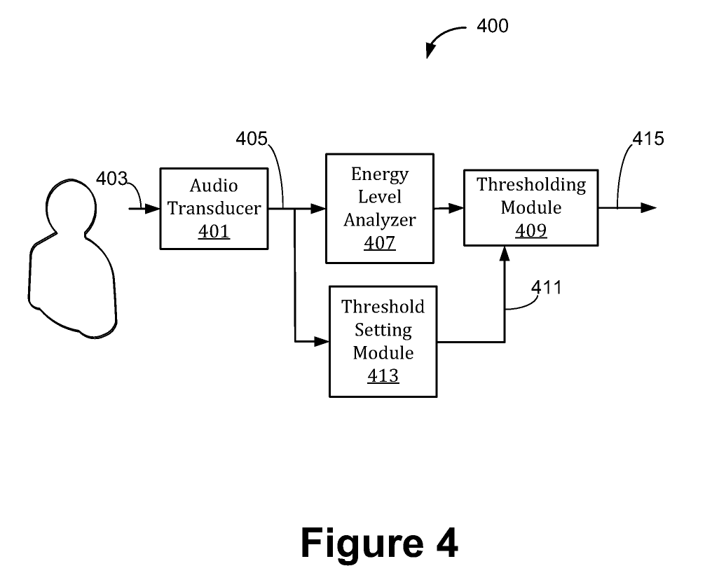

In keeping with the foregoing, a functional schematic of the voice recognition engine 180 is shown in FIG. 4. In the illustrated example, the voice recognition engine 180 includes an audio transducer 401 that produces a digitized representation 405 (“digital audio signal”) of an input analog audio signal 403. The digital audio signal 405 is input to an energy level analyzer 407, which identifies audio energy in the signal 405.

A thresholding module 409 also receiving the digital audio signal 405 then identifies the possible presence of speech based on certain thresholds 411 provided by an threshold setting module 413. The threshold setting module 413 may provide fixed energy threshold values relative to the maximum possible energy value (defined, for example, as 0 dB). A fixed threshold may set at the minimum expected speech energy level (−36 dB, for instance).

Alternatively, the thresholds supplied by the threshold setting module 413 may be adaptive thresholds. For example, the signal energy may be averaged at times when the current thresholds indicate the presence of speech (for the adapted speech energy level estimate) and may also be averaged when the current thresholds indicate the presence of background noise (for the adapted noise level estimate). Thresholds for identification of speech and noise are then set by the threshold setting module 413 based at least in part on these adaptive energy levels.

With respect to averaging, the threshold setting module 413 averages the signal via a sliding time window in an embodiment, e.g., a window of a preselected duration. Alternately the threshold setting module 413 may employ a filter with memory to perform the averaging task. Stationary noise such as car noise is identified and the adaptive thresholds are generated in an embodiment by setting a minimum number of frames for which the detected speech energy meets or exceeds the currently applicable speech threshold and the speech energy level is greater than a determined stationary noise floor. Similarly, an adaptive non-stationary noise threshold is generated in this embodiment by setting a minimum number of frames for which voice presence is detected and the speech energy level is greater than a defined dynamic noise floor. The thresholds for stationary noise and non-stationary noise need not be the same.

The threshold setting module 413 also generates long term or medium term noise floors in an embodiment, and enforces a minimum SNR threshold to prevent False Accepts when high noise is detected,. The SNR is reflective of the relative energy levels of the speech and noise components of the signal, and need not be a true or exact ratio; in an embodiment, the SNR is set as a function of the difference between the estimated speech level and the estimated noise level, e.g., expressed in dB. The SNR threshold itself is set adaptively in an embodiment by the threshold setting module 413 based on the ambient noise level. For example, at higher noise levels, the SNR threshold may be set lower than at lower noise levels.

In an embodiment of the disclosed principles, the threshold setting module 413 monitors noise conditions and sets a trigger or wakeup SNR based on ambient noise. In a high-noise environment, when the trigger is identified but the confidence score (e.g., calculated by the thresholding module 409) to establish the speaker as the owner of the device is low, the thresholding module 409 may utilize a second trigger or cause the device to request confirmation and improve the recognition models or thresholds. For example, the device may awake and display or play a query phrase such as “I think I heard you, but could you speak louder?” If the user responds with a command, the threshold setting module 413 can use the trigger characteristics and the noise characteristics during that time to improve its recognition model and update thresholds specific to the user. The output of the thresholding module 409 in an embodiment is a command or indication 415 to the device processor 140 in accordance with the user speech input, e.g., to activate a program or application, to enter a specific mode, to take a device-level or application-level action and so on.

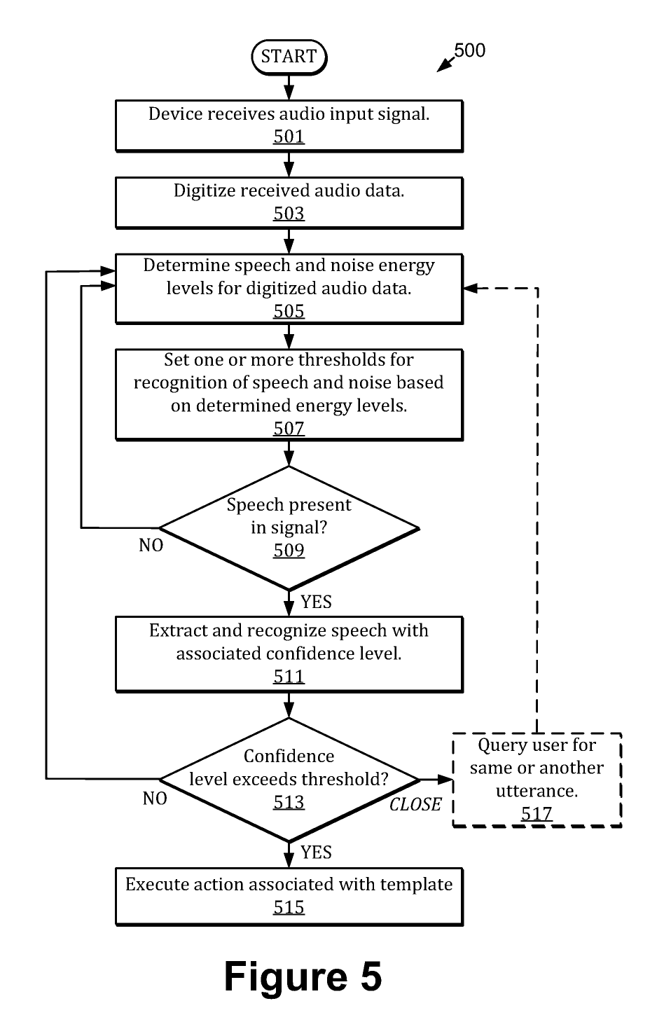

Although embodiments of the described principles may be variously implemented, the flow chart of FIG. 5 shows an exemplary process 500 for executing steps for adaptive voice recognition. The steps are explained from the device standpoint, but it will be appreciated that the steps are executed by the device processor 140 or other hardware computing element configured to read, recognize and execute instructions stored on a non-transient computer-readable medium such as RAM, ROM, CD, DVD, flash memory or other memory media. The process steps can also be viewed as instantiating and running the appropriate modules of FIG. 4.

The illustrated process 500 begins at stage 501, wherein the device receives an audio input signal. The audio input signal may be a frame of audio input or an element or unit in a stream of audio data received via a device audio input element such as a microphone. The received audio data is digitized at stage 503.

At stage 505, the digitized audio data of stage 503 is analyzed to determine speech and noise energy levels. Either level may be zero, but typically there is at least some level of noise detected. One or more thresholds for identification of speech and noise are then set at stage 507 based at least in part on the determined energy levels, and these thresholds are then used in stage 509 to determine the presence or non-presence of speech. If it is determined that speech is present in the audio signal, the speech is recognized in stage 511 by matching the speech with a prerecorded or predetermined template with an associated confidence level. Alternately the parameters computed from the speech may be matched to the trained model or models with an associated confidence level. Otherwise, the process 500 returns to stage 505.

Continuing from stage 511, it is determined at stage 513 whether the confidence level exceeds a predetermined threshold confidence level. If it is determined at stage 513 that the confidence level is above the predetermined threshold confidence level, then the action associated with the particular template or model is executed at stage 515. If instead it is determined at stage 513 that the recognized speech (or a set of parameters computed from it) does not match any recorded template (or any model) with a confidence level above the predetermined threshold confidence level, then the process returns to stage 505.

Optionally, the process 500 may instead flow to stage 517 from stage 513 if the recognized speech fails to match at a confidence level above the predetermined threshold, but does match at a confidence level within a predetermined margin below the predetermined threshold. At optional stage 517, the device queries the user to give the same or another spoken utterance, and may instruct the user to speak more clearly or more loudly. If the additional utterance can be matched to a template at stage 519, or the set of parameters computed from the additional utterance can be matched to the model then the action associated with the template or model is executed at stage 515. Otherwise, the process 500 returns to stage 505.

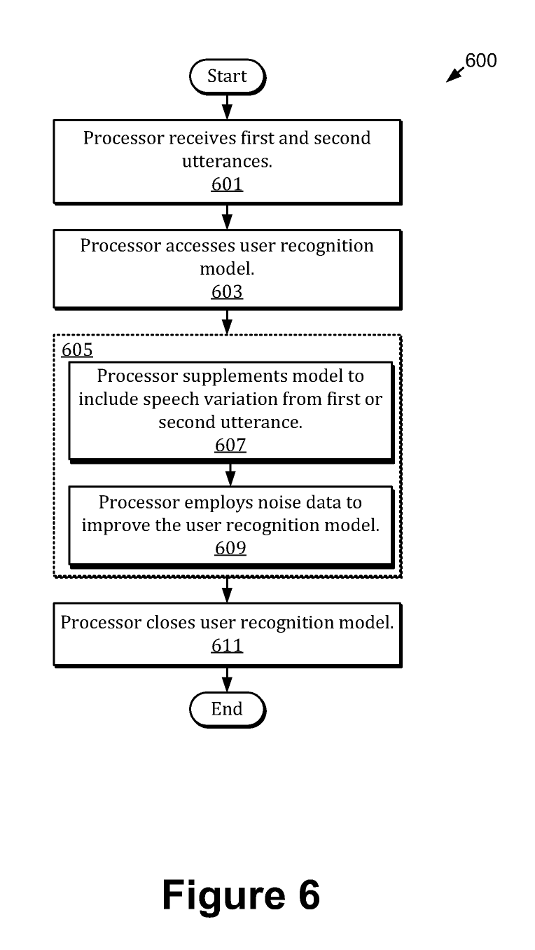

The process 600 illustrated via the flow chart of FIG. 6 shows, in greater detail, the use of a first and second utterance for user recognition model improvement in keeping with an embodiment of the disclosed principles. The second utterance may arise, for example, pursuant to a request to the user as in stage 517 of process 500.

At stage 601 of the process 600, the device processor receives the first utterance and the second utterance. It will be appreciated that the processor may also receive audio data taken before and after each utterance. The processor then accesses a user recognition model used to map speech to a particular user at stage 603. Using the received first and second utterances, the processor refines the user recognition model at stage 605, and at stage 611 the user recognition model is closed.

However, the refining of the user recognition model in stage 605 may include one or all of several sub-steps 607-609. Each such sub-step will be listed with the understanding that it is not required that all sub-steps be performed. At sub-step 607, the processor supplements the user recognition model to include a speech variation reflected in the first or second utterance. This speech variation may be a variation in pronunciation, accent or cadence, for example, and may be reflected in a difference between the utterances, or in a difference between a stored exemplar and one or both utterances.

At sub-step 609, the processor employs noise data to improve the user recognition model. In particular, in an embodiment, the processor detects noise data from the audio signal before, during and after an utterance and uses characteristics of this noise data to refine the user recognition model. As noted above, the process 600 flows to stage 611 after completion of stage 605 including any applicable sub-steps.

It will be appreciated that system and techniques for improved voice recognition accuracy in high noise conditions have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

1. A method of detecting a human utterance comprising:
receiving an audio signal containing noise;
determining a noise energy level and a speech energy level in the audio signal;
modifying a prior speech energy level threshold based at least in part on the determined noise energy level and speech energy level to generate a modified speech energy level threshold;
comparing the determined speech energy level to the modified speech energy level threshold; and
producing a presence signal indicating the presence of speech in the audio signal when the determined speech energy level exceeds the modified speech energy level threshold.

2. The method in accordance with claim 1, wherein receiving an audio signal comprises receiving audio input at a transducer to generate an analog audio signal and digitizing the analog audio signal to generate the audio signal.

3. The method in accordance with claim 1, wherein determining a noise energy level and a speech energy level in the audio signal further comprises averaging signal energy when speech is present to generate the modified speech energy level threshold and averaging signal energy when speech is not present to generate an adaptive noise threshold.

4. The method in accordance with claim 3, wherein averaging comprises applying a sliding time window.

5. The method in accordance with claim 3, wherein averaging comprises applying a filter with memory.

6. The method in accordance with claim 1, further comprising setting a minimum signal to noise ratio (SNR) when the noise energy level exceeds a predetermined noise energy trigger level, and indicating the presence of a first utterance in the audio signal only when the minimum SNR is met.

7. The method in accordance with claim 6, further comprising generating a confidence value associated with indicating the presence of user's speech, and issuing a request to speak a second utterance when the noise energy level exceeds the predetermined noise energy trigger level.

8. The method in accordance with claim 7, wherein the second utterance differs from the first utterance.

9. The method in accordance with claim 7, wherein the request to speak the second utterance comprises a request for the user to repeat the first utterance.

10. The method in accordance with claim 7, further comprising flagging the detected speech as containing a correctly identified trigger with a low confidence score and refining a user recognition model using the flagged detected speech.

11. The method in accordance with claim 10, wherein refining the user recognition model comprises supplementing the user recognition model to accept a speech variation reflected in the first or second utterance.

12. The method in accordance with claim 11, wherein the speech variation is at least one of a variation in pronunciation and a variation in cadence.

13. The method in accordance with claim 10, wherein refining the user recognition model comprises using the noise characteristics during, before and after the first utterance to improve the user recognition model.

14. A portable electronic device comprising:
an audio input receiver;
a user interface output; and
a processor configured to receive an audio signal containing noise at the audio input receiver, determine a noise energy level and a speech energy level of the audio signal, modify a speech energy to generate a modified speech energy level threshold level threshold based on the determined noise energy level and speech energy level, compare the determined speech energy level to the modified speech energy level threshold, and produce a presence signal indicating the presence of speech in the audio signal when the determined speech energy level exceeds the modified speech energy level threshold.

15. The device in accordance with claim 14, wherein the processor is further configured to determine the noise energy level and speech energy level by averaging signal energy when speech is present to generate the modified speech energy level threshold and averaging signal energy when speech is not present to generate an adaptive noise threshold.

16. The device in accordance with claim 15, wherein the processor is further configured to average signal energy by applying at least one of a sliding time window and a filter with memory.

17. The device in accordance with claim 14, wherein the processor is further configured to generate a confidence value associated with indicating the presence of user's speech, wherein the speech present in the audio signal includes a first utterance, and to cause issuance of a request to speak a second utterance when the noise energy level exceeds the predetermined noise energy trigger level.

18. The device in accordance with claim 17, wherein the processor is further configured to supplement a user recognition model to accept a speech variation reflected in the first or second utterance.

19. The device in accordance with claim 17, wherein the processor is further configured to use noise characteristics during, before and after the first utterance to improve a user recognition model.

20. A method of detecting human speech comprising:
setting a speech energy threshold to identify a speech energy level at which human speech is said to be present;
receiving an audio signal and determining a noise energy level and a speech energy level in the audio signal;
modifying the speech energy level threshold based on the noise energy level and speech energy level to generate a modified speech energy level threshold; and
comparing the speech energy level to the modified speech energy level threshold to detect the presence of speech in the audio signal.
